(19) United States
(12) Patent Application Publication
(10) Pub. No.: US 2012/0294028 A1
(43) Pub. Date: Nov. 22, 2012

(54) BALL SOCKET WITH SPRING RETENTION RING

(75) Inventors: Larry E. Wainscott, Algonac, MI (US); Mark R. Gordon, Warren, MI (US)

(73) Assignee: GM GLOBAL TECHNOLOGY OPERATIONS LLC, Detroit, MI (US)

(21) Appl. No.: 13/111,253

(22) Filed: May 19, 2011

(51) Int. Cl. F16C 11/06; F21V 21/14

(52) U.S. Cl. 362/528; 403/122; 403/144

(57) ABSTRACT

A ball and socket assembly includes a support having a plurality of arms extending between a face plate and a base, and defining a socket cup. A spherical end of a ball stud is disposed within the socket cup in a snap fit engagement with the plurality of arms. A radial biasing device is disposed annularly about an outer periphery of an upper portion of the plurality of arms to resist movement of the plurality of arms radially outward relative to the longitudinal axis, thereby increasing a retention force resisting removal of the spherical end of the ball stud from within the socket cup.

### TECHNICAL FIELD

The invention generally relates to a ball and socket assembly, and more specifically to any aimable lighting device/assembly for a vehicle including the ball and socket assembly.

### BACKGROUND

Ball and socket assemblies are used to pivotably attach a first component to a second component. For example, one or more ball and socket assemblies may be used to attach a lighting device/module of an aimable lighting device/assembly, e.g., a head aimable lighting assembly, to a housing of the aimable lighting device/assembly. The ball and socket assembly provides a pivotable connection therebetween so that the lighting device/module may pivot and/or rotate during adjustment and/or positioning of the lighting device/module. The ball and socket assembly may include a ball stud having a spherical end disposed within a socket cup in a snap fit engagement therebetween. The snap fit engagement must provide a retention force sufficient to secure the ball stud within the socket cup to prevent the ball stud from becoming dislodged from the socket cup.

### SUMMARY

A ball and socket assembly is provided. The ball and socket assembly includes a support. The support includes a face plate defining an opening, a base spaced from the face plate along a longitudinal axis, and a plurality of arms extending between the face plate and the base. The plurality of arms cooperate to define a socket cup. A ball stud, having a substantially spherical end defining a diameter, is disposed within the socket cup in a snap fit engagement with the plurality of arms. Each of the plurality of arms includes an upper portion. The upper portion is disposed adjacent the face plate, and extends radially inward toward the longitudinal axis. The upper portion defines a diameter of the opening that is smaller than the diameter of the spherical end of the ball stud. A radial biasing device is disposed annularly about an outer periphery of the upper portion of the plurality of arms. The radial biasing device is configured to resist movement of the plurality of arms radially outward relative to the longitudinal axis.

A ball and socket assembly is also provided. The ball and socket assembly includes a support. The support includes a face plate that defines an opening, a base that is spaced from the face plate along a longitudinal axis, a plurality of legs that extend between the face plate and the base, and a plurality of arms that extend between the face plate and the base. The plurality of arms cooperate to define a socket cup. A ball stud, having a substantially spherical end defining a diameter, is disposed within the socket cup in a snap fit engagement with the plurality of arms. Each of the plurality of arms includes an upper portion. The upper portion is disposed adjacent the face plate, and extends radially inward toward the longitudinal axis. The upper portion of the plurality of arms defines a diameter of the opening that is smaller than the diameter of the spherical end of the ball stud. A radial biasing device is disposed annularly about an outer periphery of the upper portion of the plurality of arms. The radial biasing device is configured to resist movement of the plurality of arms radially outward relative to the longitudinal axis. The radial biasing device includes an un-sprung inner circumference that is approximately equal to an outer circumference of the plurality of arms when the radial biasing device is in a non-expanded state. The radial biasing device is configured to resist radial expansion of the inner circumference beyond the un-sprung inner circumference. The plurality of legs cooperate to define a groove that is disposed annularly about the longitudinal axis in an outer peripheral surface of the plurality of legs. The radial biasing device is disposed within the groove.

An aimable lighting assembly for a vehicle is also provided. The aimable lighting assembly includes a frame defining an interior space. A lighting device/module is disposed within the interior space of the frame. An adjuster is attached to the frame. The adjuster is configured for adjusting a position of the lighting device/module relative to the frame. A ball and socket assembly interconnects the lighting device/module and the adjuster. The ball and socket assembly includes a support. The support includes a face plate defining an opening, a base spaced from the face plate along a longitudinal axis, and a plurality of arms extending between the face plate and the base. The plurality of arms cooperate to define a socket cup. A ball stud, having a substantially spherical end defining a diameter, is disposed within the socket cup in a snap fit engagement with the plurality of arms. The ball stud extends from the spherical end to a distal end that is coupled to the adjuster. Each of the plurality of arms includes an upper portion. The upper portion is disposed adjacent the face plate, and extends radially inward toward the longitudinal axis. The upper portion defines a diameter of the opening that is smaller than the diameter of the spherical end of the ball stud. A radial biasing device is disposed annularly about an outer periphery of the upper portion of the plurality of arms. The radial biasing device is configured to resist movement of the plurality of arms radially outward relative to the longitudinal axis.

Accordingly, the radial biasing device provides an additional retention force over and above the retention force provided by the snap fit connection between the spherical end of the ball stud and the socket cup alone, thereby increasing the overall retention force of the ball and socket assembly. The spherical end of the ball stud may still be removed from the socket cup, but most both elastically deform the plurality of arms and expand the radial biasing device to do so. The increased retention force provided by the ball and socket assembly described herein allows the ball and socket assembly to secure heavier components without failure.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of a aimable lighting assembly.

FIG. 2 is a schematic exploded perspective view of a ball and socket assembly.

FIG. 3 is a schematic cross sectional view of the ball and socket assembly cut along a plane bisecting a pair of opposing arms of the ball and socket assembly.

FIG. 4 is a schematic cross sectional view of the ball and socket assembly cut along a plane bisecting a pair of opposing legs of the ball and socket assembly.

FIG. 5 is a schematic plan view of a radial biasing device of the ball and socket assembly.

FIG. 6 is a schematic plan view of an edge of the radial biasing device.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

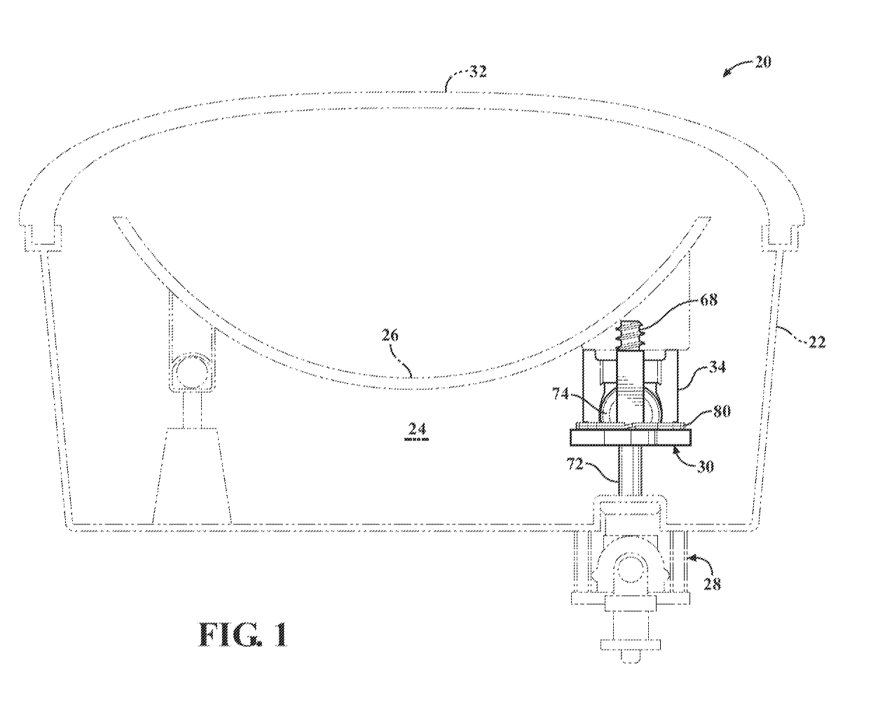

Referring to the Figures, wherein like numerals indicate like parts throughout the several views, an aimable lighting assembly is shown generally at 20 in FIG. 1. The aimable lighting assembly 20 is for a vehicle, and may be shaped, sized and/or configured in any suitable manner to fit the vehicle.

Referring to FIG. 1, the aimable lighting assembly 20 includes a frame 22. The frame 22 defines an interior space 24, within which a lighting device/module 26 is disposed. The aimable lighting assembly 20 further includes an adjuster 28 attached to the frame 22, and a ball and socket assembly 30 interconnecting the adjuster 28 and the lighting device/module 26. The adjuster 28 is configured to adjust a position of the lighting device/module 26 relative to the frame 22 to aim the light projected from the aimable lighting assembly 20. While the aimable lighting assembly 20 is shown with only a single adjuster 28 and a single ball and socket assembly 30, it should be appreciated that the aimable lighting assembly 20 may include multiple adjusters 28, with multiple ball and socket assemblies 30 to allow the lighting device/module 26 to be adjusted both horizontally and vertically. A lens 32 is attached to the frame 22 to seal and enclose the interior space 24 and protect the lighting device/module 26 and a light bulb (not shown) from damage.

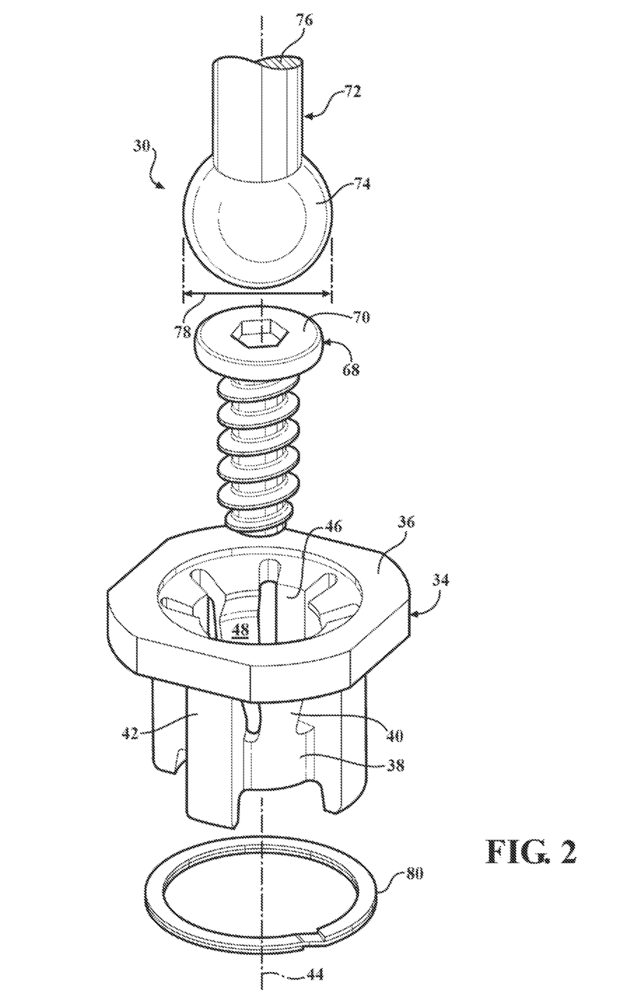

Referring to FIGS. 2 through 4, the ball and socket assembly 30 includes a support 34. The support 34 may include and be manufactured from a polymer material, including but not limited to nylon. The support 34 includes a face plate 36, a base 38, a plurality of arms 40 and a plurality of legs 42. The face plate 36 and the base 38 are spaced from each other along a longitudinal axis 44, with the plurality of arms 40 and the plurality of legs 42 extending between the face plate 36 and the base 38. The face plate 36 defines an opening 46 through a central region thereof, which is concentrically located with the longitudinal axis 44.

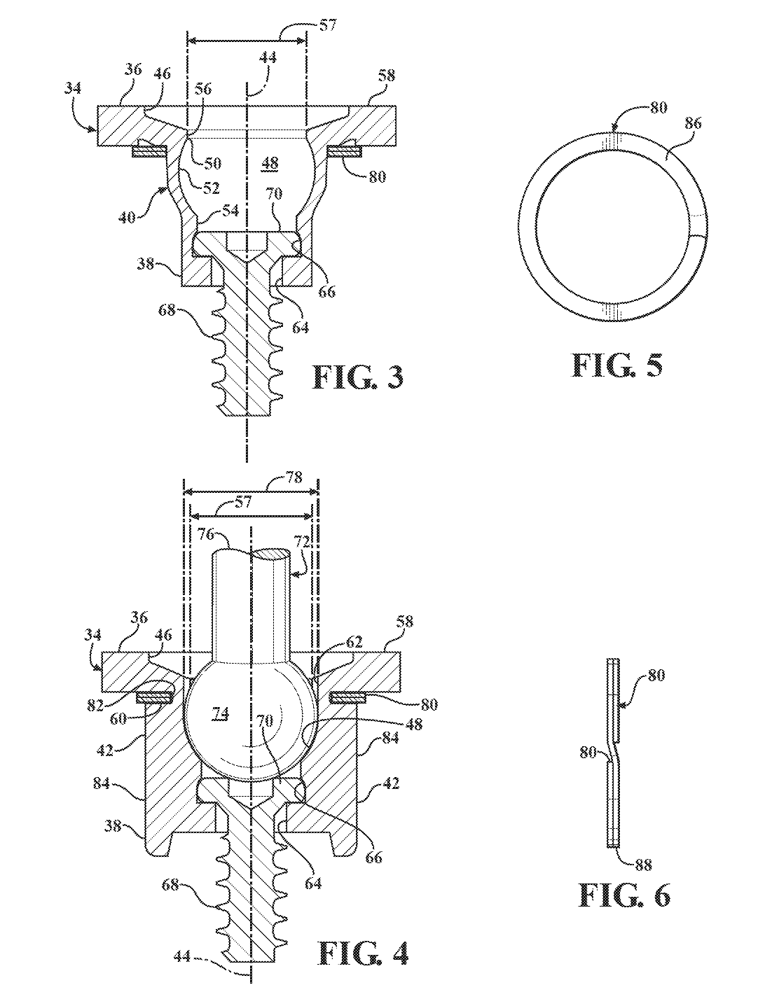

The plurality of arms 40 cooperate to define a socket cup 48 therebetween, which is accessible through the opening 46. As best shown in FIG. 3, the socket cup 48 defines a substantially spherical shape. Each of the plurality of arms 40 includes an upper portion 50, a middle portion 52 and a lower portion 54. Referring to FIG. 3, the upper portions 50 of the arms 40 are disposed adjacent the face plate 36, and include a radial inner surface 56 relative to the longitudinal axis 44 that extends radially inward toward the longitudinal axis 44. The upper portions 50 of the arms 40 cooperate to define a diameter 57 of the opening 46 disposed on an upper surface 58 of the face plate 36. The lower portions 54 of the arms 40 are disposed adjacent the base 38 of the support 34, with the middle portions 52 of the arms 40 disposed between the upper portions 50 and the lower portions 54. While the ball and socket assembly 30 is shown with four arms 40, it should be appreciated that the ball and socket assembly 30 may include any number of arms 40.

The plurality of legs 42 provide support 34 to the face plate 36, to prevent the face plate 36 from flexing or substantially moving during insertion of a spherical end 74 of a ball stud 72 into the socket cup 48 (described in greater detail below). The legs 42 include an upper portion 60 disposed adjacent the face plate 36. An inner radial surface 62 of the upper portions 60 of the legs 42 extend generally parallel with the longitudinal axis 44, with the upper portions 50 of the arms 40 extending farther inward toward the longitudinal axis 44 than the upper portions 60 of the legs 42. As such, the legs 42 do not operate to retain the spherical end 74 of the ball stud 72 within the socket cup 48. While the ball and socket assembly 30 is shown with four legs 42, it should be appreciated that the ball and socket assembly 30 may include any number of legs 42.

Referring to FIGS. 3 and 4, the base 38 of the support 34 defines a bore 64 extending therethrough. The bore 64 is concentric with the longitudinal axis 44. The base 38 further defines a chamber 66 or undercut disposed annular about the bore 64. The chamber 66 is disposed between the socket cup 48 and the base 38. A mounting screw 68 is disposed within the bore 64, with a head 70 of the mounting screw 68 disposed within the chamber 66.

The ball and socket assembly 30 further includes a ball stud 72. The ball stud 72 includes a substantially spherical end 74 disposed within the socket cup 48, and extends to a distal end 76 that is coupled to the adjuster 28. The spherical end 74 of the ball stud 72 defines a substantially spherical shape having a diameter 78. The shape and size of the spherical end 74 of the ball stud 72 is approximately equal to the shape and size of the socket cup 48. The diameter 57 of the opening 46 is smaller than the diameter 78 of the spherical end 74 of the ball stud 72. Accordingly, insertion of the spherical end 74 of the ball into the socket cup 48 causes elastic deformation of the upper portions 50 of the arms 40 and radial movement of the arms 40 relative to the longitudinal axis 44 to allow passage of the spherical end 74 of the ball stud 72 through the opening 46. Upon the spherical end 74 of the ball stud 72 being positioned within the socket cup 48, the upper portions 50 of the arms 40 resiliently move back into their initial position prior to the elastic deformation and radial movement thereof to axially secure the spherical end 74 of the ball stud 72 in place within the socket cup 48 against axial movement along the longitudinal axis 44. Accordingly, the spherical end 74 of the ball stud 72 is disposed within the socket cup 48 in a snap fit engagement with the plurality of arms 40.

Referring to FIGS. 2 through 3, a radial biasing device 80 is disposed annularly about an outer periphery of the upper portions 50 of the plurality of arms 40. As shown in FIG. 4, the plurality of legs 42 cooperate to define a groove 82 disposed annularly about the longitudinal axis 44, adjacent the upper portions 50 of the arms 40. The groove 82 is disposed in an outer peripheral surface 84 of the plurality of legs 42. The radial biasing device 80 is disposed within the groove 82.

The radial biasing device 80 is configured to resist movement of the plurality of arms 40 radially outward relative to and away from the longitudinal axis 44. When the radial biasing device 80 is in a non-expanded state, such as shown in FIGS. 3 and 4, the radial biasing device 80 includes an un-sprung inner circumference that is approximately equal to an outer circumference defined by the plurality of arms 40. The radial biasing device 80 is configured to resist radial expansion of the inner circumference beyond the un-sprung inner circumference. Accordingly, movement of the spherical end 74 of the ball stud 72 out of the socket cup 48 urges the plurality of arms 40 to deflect radially outward away from the longitudinal axis 44. However, because the plurality of arms 40 are bounded by the radial biasing device 80, the plurality of arms 40 must expand the radial biasing device 80 from the non-expanded state to an expanded state to allow the spherical end 74 of the ball stud 72 to pass through the opening 46 and out of the socket cup 48. Therefore, the radial biasing device 80 increases the force required to remove the spherical end 74 of the ball stud 72 from the socket cup 48.

The radial biasing device 80 may include but is not limited to one of a spring retention ring, a spring clip or some other similar device. For example, referring to FIGS. 5 and 6, the radial biasing device 80 is shown as a spring retention ring. The spring retention ring includes an elongated planar strip 86 of material, such as stainless steel or some other similar material, formed into a coil. The coil defines at least two parallel and adjacent laminations 88. Because the ends of the planar strip 86 of material are not attached to each other, the spring retention ring is capable of expanding radially outward.

While the best modes for carrying out the invention have been described in detail, those familiar with the art to which this invention relates will recognize various alternative designs and embodiments for practicing the invention within the scope of the appended claims.

1. A ball and socket assembly comprising:
a support having a face plate defining an opening, a base spaced from the face plate along a longitudinal axis, and a plurality of arms extending between the face plate and the base and cooperating to define a socket cup;
a ball stud having a substantially spherical end defining a diameter disposed within the socket cup in a snap fit engagement with the plurality of arms;
wherein each of the plurality of arms includes an upper portion disposed adjacent the face plate and extending radially inward toward the longitudinal axis to define a diameter of the opening that is smaller than the diameter of the spherical end of the ball stud; and
a radial biasing device disposed annularly about an outer periphery of the upper portions of the plurality of arms and configured to resist movement of the plurality of arms radially outward relative to the longitudinal axis.

2. A ball and socket assembly as set forth in claim 1 wherein the radial biasing device includes one of a spring retention ring or a spring clip.

3. A ball and socket assembly as set forth in claim 1 wherein the radial biasing device includes a spring retention ring including an elongated planar strip formed into a coil defining at least two laminations.

4. A ball and socket assembly as set forth in claim 1 further comprising a plurality of legs extending between the face plate and the base.

5. A ball and socket assembly as set forth in claim 4 wherein the plurality of legs cooperate to define a groove disposed annularly about the longitudinal axis, with the radial biasing device is disposed within the groove.

6. A ball and socket assembly as set forth in claim 5 wherein the groove is disposed in an outer peripheral surface of the plurality of legs.

7. A ball and socket assembly as set forth in claim 1 wherein the radial biasing device includes an un-sprung inner circumference approximately equal to an outer circumference of the plurality of arms when the radial biasing device is in a non-expanded state.

8. A ball and socket assembly as set forth in claim 7 wherein the radial biasing device is configured to resist radial expansion of the inner circumference beyond the un-sprung inner circumference.

9. A ball and socket assembly as set forth in claim 1 wherein the base defines a bore concentric with the longitudinal axis, and further comprising a mounting screw disposed within the bore.

10. A ball and socket assembly as set forth in claim 9 wherein the base defines a chamber disposed between the socket cup and the base, with a head of the mounting screw disposed within the chamber.

11. A ball and socket assembly comprising:
a support having a face plate defining an opening, a base spaced from the face plate along a longitudinal axis, a plurality of legs extending between the face plate and the base, and a plurality of arms extending between the face plate and the base and cooperating to define a socket cup;
a ball stud having a substantially spherical end defining a diameter disposed within the socket cup in a snap fit engagement with the plurality of arms;
wherein each of the plurality of arms includes an upper portion disposed adjacent the face plate and extending radially inward toward the longitudinal axis to define a diameter of the opening that is smaller than the diameter of the spherical end of the ball stud; and
a radial biasing device disposed annularly about an outer periphery of the upper portions of the plurality of arms and configured to resist movement of the plurality of arms radially outward relative to the longitudinal axis;
wherein the radial biasing device includes an un-sprung inner circumference approximately equal to an outer circumference of the plurality of arms when the radial biasing device is in a non-expanded state, and is configured to resist radial expansion of the inner circumference beyond the un-sprung inner circumference; and
wherein the plurality of legs cooperate to define a groove disposed annularly about the longitudinal axis in an outer peripheral surface of the plurality of legs, with the radial biasing device disposed within the groove.

12. An aimable lighting assembly for a vehicle, the aimable lighting assembly comprising:
a frame defining an interior space;
a lighting device/module disposed within the interior space;
an adjuster attached to the frame and configured for adjusting a position of the lighting device/module relative to the frame; and
a ball and socket assembly interconnecting the lighting device/module and the adjuster, the ball and socket assembly comprising:
a support having a face plate defining an opening, a base spaced from the face plate along a longitudinal axis, and a plurality of arms extending between the face plate and the base and cooperating to define a socket cup;
a ball stud having a substantially spherical end defining a diameter disposed within the socket cup in a snap fit engagement with the plurality of arms, and extending from the spherical end to a distal end coupled to the adjuster;
wherein each of the plurality of arms includes an upper portion disposed adjacent the face plate and extending radially inward toward the longitudinal axis to define a diameter of the opening that is smaller than the diameter of the spherical end of the ball stud; and
a radial biasing device disposed annularly about an outer periphery of the upper portion of the plurality of arms and configured to resist movement of the plurality of arms radially outward relative to the longitudinal axis.

13. An aimable lighting assembly as set forth in claim 12 further comprising a plurality of legs extending between the face plate and the base.

14. An aimable lighting assembly as set forth in claim 13 wherein the plurality of legs cooperate to define a groove disposed annularly about the longitudinal axis, with the radial biasing device is disposed within the groove.

15. An aimable lighting assembly as set forth in claim 14 wherein the groove is disposed in an outer peripheral surface of the plurality of legs.

16. An aimable lighting assembly as set forth in claim 12 wherein the radial biasing device includes an un-sprung inner circumference approximately equal to an outer circumference of the plurality of arms when the radial biasing device is in a non-expanded state.

17. An aimable lighting assembly as set forth in claim 16 wherein the radial biasing device is configured to resist radial expansion of the inner circumference beyond the un-sprung inner circumference.

18. An aimable lighting assembly as set forth in claim 12 wherein the base defines a bore concentric with the longitudinal axis, and wherein the ball and socket assembly further includes a mounting screw disposed within the bore and in threaded engagement with a boss of the lighting device/module.

19. An aimable lighting assembly as set forth in claim 18 wherein the base defines a chamber disposed between the socket cup and the base, with a head of the mounting screw disposed within the chamber.
